(19) United States
(12) Patent Application Publication
(10) Pub. No.: US 2011/0211107 A1
(43) Pub. Date: Sep. 1, 2011

(54) Method to perform sobel calculations and normalization for auto-focus in a digital camera

(75) Inventor: Lothar Muench, Dettingen unter Teck (DE)

(73) Assignee: Digital Imaging Systems GmbH

(21) Appl. No.: 12/660,560

(22) Filed: Mar. 1, 2010

(51) Int. Cl. H04N 5/232

(52) U.S. Cl. 348/349; 348/E05.045

(57) ABSTRACT

A focus motor of a digital camera is moved to a point of focus from which image data is integrated and evaluated for sharpness and luminance. When the focus motor is stopped, a delay is initiated to allow integration of the image data from which a Sobel value and a luminance value are determined to allow the calculation of a focus value to be calculated from the ratio of the Sobel value to the luminance value. Once the focus value is calculated, the next motor position is determined from which a next focus value is determined.

This application is related to U.S. patent application docket number DI09-020, Ser. No. ______, filed on ______ , and assigned to the same assignee as the present invention, and which is herein incorporated by reference in its entirety.

### BACKGROUND OF THE INVENTION

1. Field of Invention. The present invention is related to digital camera auto-focus and in particular Sobel calculations and normalization.

2. Description of related art.

In the digital cameras of today automatic lens focus (auto-focus) is critical for producing pictures that the user expects and desires. The digital camera provide a continuous image before and during the operation to take a picture, and changes as the user moves the camera to take a picture ranging from close-up pictures to distant pictures of buildings and landscape. The movement of an auto-focus lens at the same time a picture is being focused provides a complex situation that the focusing algorithms built into the camera must control.

US Patent Application Publication No. 2009/0115886 A1 (Chen) is directed to an auto focus method for a digital camera, wherein a single image is used to obtain a lens focal position by using an edge detection algorithm to compute distance to an object. US Patent Application Publication No. 2009/0102963 A1 (Yeo et al.) is directed to an auto focus image system, which includes an image sensor coupled to a controller that captures an image that has at least one edge with a width, wherein the controller generates a focus signal that is a function of the edge width. In US Patent Application Publication No. 2008/0181595 A1 (Pnueli et al.) a focusing method is directed to receiving a focusing image and shifting the focusing image to obtain a shifted focusing image whereby a focus metric is calculated from the focusing image and the shifted focusing image. US Patent Application Publication No. 2007/0002152 A1 (Fujiwara) is directed to a digital camera that has an edge enhancing section to enhance edges of image data whereby a focus is determined to be good or bad and adjusts the degree of edge enhancement wherein focusing time is shortened. In U.S. Pat. No. 7,283,663 B2 (Sobel et al.) a method and apparatus is directed to interpolating color image information wherein a processor determines whether there is an edge in the vicinity of a target pixel in which long scale interpolation is performed on image data if there is not an edge in close proximity of the target pixel. In U.S. Pat. No. 7,280,149 B2 (Weintroub et al.) a technique is directed to measuring optimum focus position of a lens in a digital camera, wherein a compressed file associated with an image size increases monotonically as an image is brought into focus. U.S. Pat. No. 5,563,658 (Parulski et al.) is directed to a technique for focusing a digital camera wherein the average contrast of a central portion of an image is used to determine the focus of an image.

Controlling the movement of the auto-focus lens in concert with focus detection algorithm is essential to producing a well-focused image. It is essential that a new image be not formed before the previous image is analyzed for focus quality, and the lens adjusted accordingly.

### SUMMARY OF THE INVENTION

It is an objective of the present invention to stop a lens focus motor of a digital camera to setup a focus window from which a Sobel and a Luminance value are extracted to determine image focus and calculate a new focus motor position. Care must be taken that the motor movement does not influence the Sobel value, which means that there is no motor movement when the integration of the actual image starts.

It is also an objective of the present invention to shift the Sobel value (Sobelval) and the luminance value (Lumval) to provide accuracy in calculating the ratio of Sobelval/Lumval to determine sharpness of an image.

In the present invention an auto-focus of a digital camera is performed by measuring the sharpness of an image, or the sharpness of a portion of an image to determine the focus of the lens of the digital camera. To determine the focus of the lens adjustment point set by a position of focus motor, a calculation of a focus value is made wherein focus value=Sobelval/Lumval. The Sobelval is a measure of the sharpness of an edge in the image or image portion and the Lumval is a measure of the brightness in the vicinity of the edge. Both the Sobelval and the Lumval are shifted until they are in a given range to provide the best accuracy (e.g. Sobelval must be in the range between 2exp29 and 2exp30). The Lumval itself is shifted proportional to the number of bits the Sobelval is shifted.

When obtaining a focus of an image of a digital camera, a lens focus motor adjusts a movable lens set toward a focus point. Care must be taken that the next image, which is used for focus calculation is without influence of the previous motor movement. A delay is used with the same value as the actual integration time to prevent the influence of a moving motor during image integration. Normally the delay is handled by a series of IRQs, but also could be created with a timer. After an integrated image without motor movement is detected a Sobel window is set up comprising a portion of interest of the image being evaluated for focus quality. The aforementioned values of Sobelval and Lumval are fetched and are shifted into a given range. The quality (goodness) of the present focus is evaluated by calculating focus value=Sobleval/Lumval. Then the lens motor is moved to a new position in an attempt to find the optimum position of the adjustable lens driven by the lens focus motor

### BRIEF DESCRIPTION OF THE DRAWINGS

This invention will be described with reference to the accompanying drawings, wherein:

FIG. 1 is a method of the present invention to determine a focus position of a lens focus motor and therefore the focus of a digital image in a digital camera;

FIG. 2 is an overview of a method of the present invention for calculating a value of focus of the lens of a digital camera;

FIG. 3 is a method of the present invention for calculating a value of focus of the lens of a digital camera; and

FIG. 4 is a timing diagram of the present invention of the VSYNC signal and the operations to determine a focus of an image of a digital camera.

### DETAILED DESCRIPTION OF THE PREFERRED EMBODIMENT

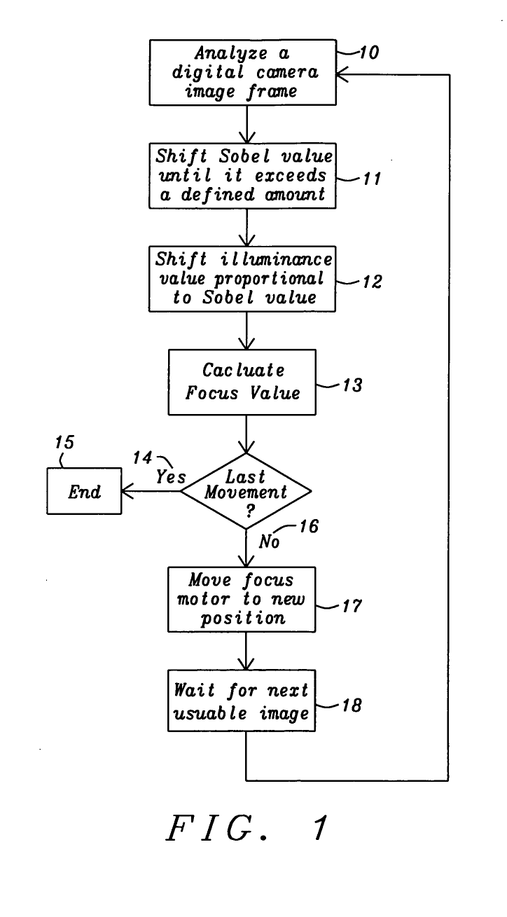

In FIG. 1 is shown a method of the present invention for determining the focus of a digital camera comprising a motor driven lens focus mechanism. An image frame at a focus motor position, which establishes a lens focus setting, is analyzed for sharpness 10. To accomplish the analysis of sharpness (or focus) a Sobel value of an edge within the image is extracted from the image frame data and shifted 11 until the value is within a given range to provide data with increased sensitivity and resolution. A luminance value extracted from image frame data is also shifted 12 proportional to the shifted Sobel value until the value is also in a given range.

To get best accuracy of the resulting focus value the Sobel value (Sobelval) is shifted to the right or to the left until the resulting value is within a given range. This approach is needed because the Sobelval is hardly influenced by the luminance of the scene that is being focused. By shifting the Sobelval into a predefined range the resulting focus value gets a comparable value.

If the Sobelval exceeds a given upper range it is shifted to the right to reduce the Sobelval. A shift to the right means a truncation of the lower ordered bits. If the Sobelval is below a given lower range it is shifted to the left to increase the value. The additional used lower ordered bits are filled with 0 (zero) when shifting to the left. After these shift operations the resulting Sobelval is between the lower and upper boundaries of the given range. After the Sobelval is shifted, the amount of shifted bits is used to shift the Lumval in the same way to get into the same output range.

A focus value of the image, or a portion of the image, is calculated 13 by dividing the Sobel value by the luminance value. This division is necessary to minimize the luminance influence of the Sobelval. The Sobelval is influenced by different aspects of luminance, comprising, lens position effects on image luminance and flicker from artificial light (50/60HZ). When the Sobelval is normalized by the Lumval the luminance influence on the resulting focus value can be minimized. The normalization is necessary to increase reliability of the focus system because the resulting focus value for the same scene at different lightning conditions is almost the same.

The autofocus system checks if an additional movement is needed to find the best focusing point. If no additional movement is needed 14 the sequence is stopped 15 wherein the best focusing point is found or an error has occurred. If the best focus position has not been found 16, the focus motor is moved to a new calculated position 17. After waiting for the focus motor to finish movement, the next usable image is acquired 18, and the next image is analyzed 10.

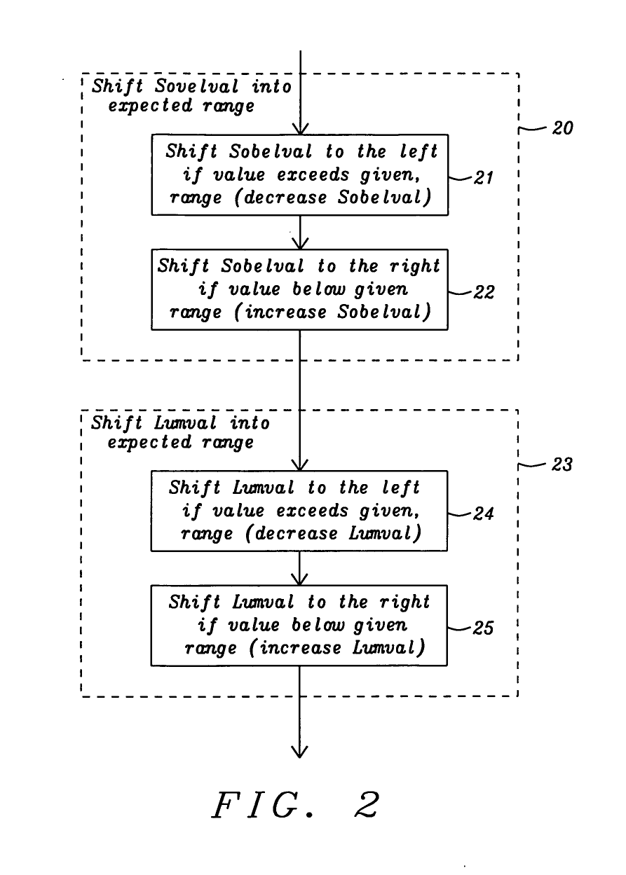

In FIG. 2, an overview of the method is shown that demonstrates how the Sobelval and the Lumval is shifted into a predefined range 20. After the Sobelval is extracted from the image the value is checked. If the Sobelval exceeds an upper limit of a given range, the Sobelval is reduced by shifting bitwise to the left 21. If the value is below the lower limit of that given range it is increased by shifting bitwise to the right 22.

The Lumval is also shifted into a given range 23. The Lumval must be shifted in the same way than the Sobelval is shifted. If the Sobelval is shifted to the left the Lumval is also shifted to the left 24, or if the Sobelval is shifted to the right the Lumval is also shifted to the right 25. The shift between Sobelval and Lumval should be proportional. After a focus value is calculated the autofocus algorithm determines the next focus motor position. This sequence (motor movement, sobel/lum calculation, next motor position calculation) is handled in a loop until a focus position is found or an error occurrs and no focus could be found.

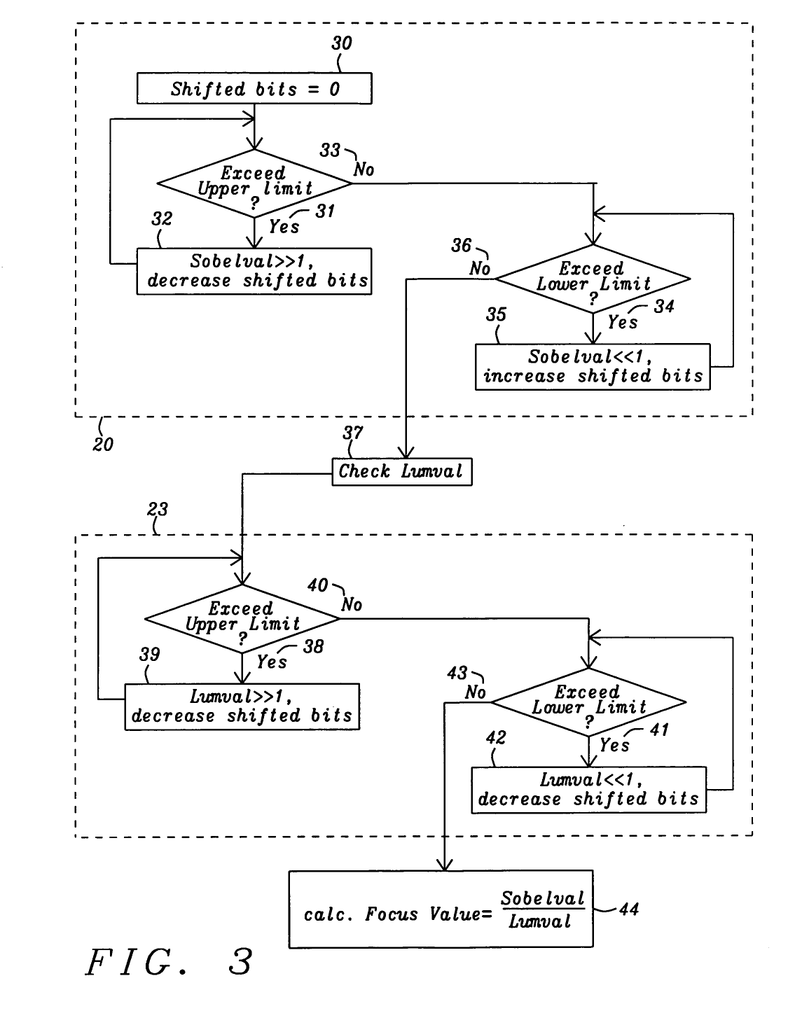

In FIG. 3 is shown the method for calculating a value of focus of the lens of a digital camera of the present invention in detail. Image data from a Sobel window of an image frame for a focus window (Sobel window) comprising focus value (Sobelval) and luminance value (Lumval) are shifted such that the resulting values are within a given range.

A variable indicates how many bits the Sobelval is shifted to the left or right. Before starting this value is set to zero 30. The examined Sobelval from the focus window (Sobel window) is checked to see if the value exceeds the upper limit of a given range. If the Sobelval exceeds this limit 31, the Sobelval is shifted to the right by one bit. The lowest bit is truncated and the variable handling the number of shifted bits is decreased 32. The new Sobelval is again checked for the value exceeding the upper limit of the range. If the value is now within the range 33, the lower range of the Sobelval is checked in a similar fashion 33. If the Sobelval exceeds the upper limit, the value is shifted to the right for an additional bit. This loop is performed until the Sobelval is below the upper limit of the range.

After the upper limit is checked the resulting Sobelval is checked against the lower limit of the range. If the value is below the lower limit 34, the Sobelval is shifted to the left by one bit 35. The lowest bits are filled with 0 (zero) when shifting to the left. The variable handling the number of shifted bits is increased 35. If the value is now within the range 36, the Lumval is checked 37 and should be shifted proportional to the Sobelval . If the Sobelval is below the lower limit, the value is shifted to the left for an additional bit. This loop is performed until the Sobelval exceeds the lower limit of the range.

To shift the Lumval similarly to the Sobelval the number of shifted bits is used to check if the Lumval needs to be shifted to the left or to the right. The variable, which handles the number of shifted bits, is checked. If it is above a given upper shift limit 38, the Lumval is shifted to the right 39. The lowest bits are truncated when shifting to the right, and the number of shifted bits is decreased 39. The new number of shifted bits is again checked to see if it is above the given limit. If the value is now within the expected range 40, the upper limit of the shifted bits is checked . If the number of bits is below the upper limit the Lumval is shifted to the right for an additional bit.

After the upper limit of the number of shifted bits is checked, the Lumval is checked against the lower limit. If the number of shifted bits exceeds the lower shifted bits limit 41, the Lumval is shifted to the left. Lowest bits are filled with 0 (zero), and the number of shifted bits is increased 42. If the number of shifted bits is within the given range the Lumval is shifted into the correct range , the focus value is calculated 44.

The Lumval sequence is needed to take care that the Lumval is shifted in the same way that the Sobelval is shifted. The resulting focus value is a normalization of the Sobelval by the Lumval. By shifting both values into given ranges the resulting value is always in the same output range. The dependency of the luminance can be mostly eliminated and the Sobelval is now divided by the Lumval, which leads to the resulting sharpening value (focus value) 44.

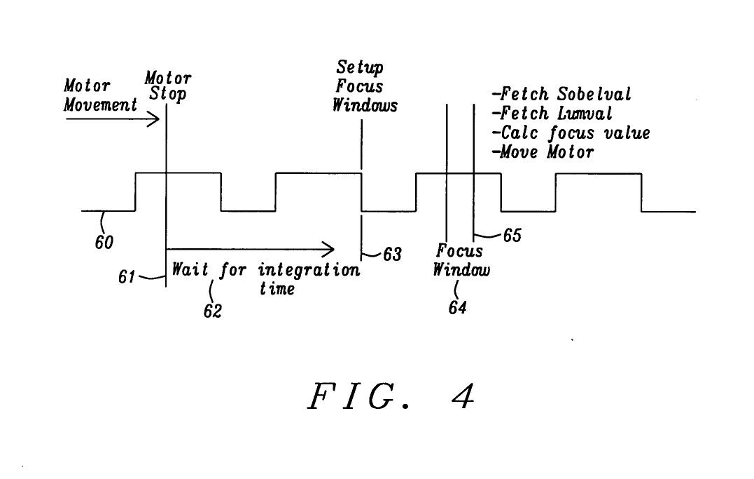

In FIG. 4 is shown a timing diagram of the present invention of the VSYNC (vertical synchronization) signal and the operations to determine a focus of an image of a digital camera. The motor driving the focus 60 of one or more lens is brought to a stop at a predetermined position 61. When the motor stops, a delay of at least the integration time is needed to prevent that the sobel window from being integrated during the motor movement 62. On the next falling edge of the VSYNC signal a focus window is set up 63. This additional delay prevents a motor movement during the integration time of the next sobel window (focus window) 64. The focus window occurring during next positive VSYNC pulse allows image sharpness data, for example Sobel values (Sobelval) and luminance values (Lumval) to be fetched from the integrated image data 64. A focus value is calculated from the ratio of image sharpness to luminance, or Sobelval to Lumval for instance, at the end of the focus window 65. From the focus value calculation a new motor position is calculated .and the focus motor is moved to a new focusing location.

While the invention has been particularly shown and described with reference to preferred embodiments thereof, it will be understood by those skilled in the art that various changes in form and details may be made without departing from the spirit and scope of the invention.

What is claimed is:

1. A method for determining the focus of an adjustable lens of a digital camera; comprising:
a) stopping a motor that adjusts a lens set for focus;
b) integrating an image focused by said lens;
c) waiting for at least an integration time when said motor stopped;
d) setting up a focus window within said image;
e) fetching focus data from said image, comprising a focus value and a luminance value;
f) determining a value of focus by calculating the ratio of the focus value to the luminance value;
g) calculating a new position of said motor using said ratio; and
i) moving motor to a new adjustment setting and return to step a).

2. The method of claim 1, wherein stopping said motor is done when the motor reaches a previous calculated lens adjustment point.

3. The method of claim 1, wherein integrating said image comprises collecting together pixel data of an image for focus analysis.

4. The method of claim 1, wherein waiting for at least the integration time controlled by a first and second IRQ to allow time for completion of the integrating of said image.

5. The method of claim 1, wherein setting up of said focus window comprises establishing a region of said image for focus analysis.

6. The method of claim 1, wherein said focus value is a Sobel value indicating a sharpness of an edge within the focus window.

7. The method of claim 1, wherein calculating said new position of the motor comprises the relative difference between said focus value and that focus value calculated for a previous motor position.

8. A lens focusing system; comprising:
a) a digital camera with an adjustable focus lens;
b) a focus motor coupled to said lens;
c) said focus motor moved to a point of focus; and
d) a delay initiated at said point of focus to allow time to integrate said image data from which a focus value is calculated and a next point of focus determined, where after the focus motor moved to the next point of focus.

9. The system of claim 8, wherein said focus value is the ratio of image sharpness to image luminance.

10. The system of claim 9, wherein said focus value indicating image sharpness is determined by a Sobel value calculation.

11. The system of claim 10, wherein said focus value comprises data for sharpness and luminance that is shifted into a given range to increase sensitivity and resolution of a calculation of focus value.
